(19) United States
(12) Patent Application Publication
(10) Pub. No.: US 2002/0112232 A1
(43) Pub. Date: Aug. 15, 2002

(54) System and process for building host computers

(76) Inventors: James A. Ream, Marriottsville, MD (US); Patrick R. Vecchio, Washington, DC (US)

Correspondence Address: REED SMITH LLP, 2500 ONE LIBERTY PLACE, 1650 MARKET STREET, PHILADELPHIA, PA, 19103, US

(21) Appl. No.: 09/783,745

(22) Filed: Feb. 15, 2001

(51) Int. Cl. G06F 9/445

(52) U.S. Cl. 717/176

(57) ABSTRACT

The present invention is a system and method for automatically installing software onto a computer. The system includes a build server and build generating station, which may be the same computer. The build server is connected to a recipient computer via a network. The build server includes a library of software that is installable onto a recipient computer. The build generating station includes software for generating build plans, the build plans containing instructions for executing software installation programs. The build plans are transferable to a recipient computer, such as through a network or manual transfer of tangible media. The method involves creating a build plan defining software to be installed onto a recipient computer, transferring the build plan to the recipient computer, and executing the build plan on the recipient computer, where the recipient computer accesses files and data needed for the installation from a build server via a network.

### FIELD OF THE INVENTION

The present invention pertains to the installation of software onto computers, and more particularly to the automated installation of software onto recipient computers to allow the recipient computers to be prepared in a rapid and efficient manner.

### BACKGROUND OF THE INVENTION

Web-site hosting is a significant portion of the Internet commerce infrastructure. Web hosts provide the hardware, software, and support resources necessary for individuals and companies to create an Internet presence. Internet presences are often in the form of web-sites, which present an individual's or a company's interface with their target audience. An example of such an interface could be the web-site of an automotive manufacturer, who desires to inform potential customers of the vehicles available, special promotions, and the locations of dealers near specific visitors to the manufacturers web-site. Other companies may desire to present more involved web-sites, such as sites that provide access to applications, such as word-processing or accounting software.

Relying on web hosts to provide the services and hardware necessary for hosting these web sites allows businesses to only pay for hosting resources they use, rather than requiring them to procure and staff all of the resources potentially required to host their web-site. The efficiencies inherent in out-sourcing the hosting services may increase where applications, with their increased resource requirements, are being hosted on the web-site.

The number and capacity of computers hosting a web-site for the Internet must be matched to the usage and resource requirements of the web-site or application. It is difficult, however, to accurately predict usage demands, since the popularity of a web-site or application can vary. A sharp decrease in site utilization may occur due to the introduction of a competing web-site or product. When the web-site presents an application, periodic demands may also vary the resource requirement. For example, for an accounting application presented over the Internet, periodic accounting requirements due to SEC reporting requirements may drastically increase the demand on the accounting application near the end of each quarter.

It is therefore of primary importance to be able to adjust the capacity of the resources provided for hosting web-sites and in particular for application hosting, in as rapid a fashion as possible, by increasing or decreasing the number of computers being used to host the web-site or application. Over-hosting an application, such as providing more computers than are necessary, may incur costs in providing and operating the under-utilized computers. Under-hosting an application by providing fewer computers than are required to meet demand may result in slow response times for users of the web-site or application, resulting in customer dissatisfaction.

Accordingly, it is important that web hosts be able to increase the number of computers hosting an application as rapidly as possible. Installing the required software, however, is not necessarily a frequently repeated process, and is further a process requiring large amounts of manual intervention as different stages of the installation are reached. Also, the large number of individual software applications that may need to be installed requires significant efforts to ensure that only current versions of software are installed.

Thus, in order to provide rapid configuration of computers, skilled operators must be available on call should a computer need to be prepared. Maintaining a pool of skilled operators incurs costs associated with retaining the personnel, as well as with efficiently utilizing the personnel when the demand for configuring computers is low. Since demand for configuring computers is not necessarily a stable requirement, demands for configuring computers may outpace the availability of skilled operators during one period, while leaving the skilled operators under-utilized during another. As such, limitations in the availability of skilled operators can delay the configuring of computers required for web-hosting, resulting in a tendency to over-host an application to minimize capacity issues.

It is therefore an object of the present invention to provide a system and method that allows the sequential installation of software onto a recipient computer with a minimum of operator involvement. It is also an object of the present invention to incorporate a feedback system that assists operators in locating an event that causes the installation of software to be aborted.

It is also an object of the present invention to improve the efficiency with which servers can be built. Such an improvement is inherent in the claimed system and process in that operator intervention requirements are minimized, easing the constraints of having trained personnel available to install software onto a recipient computer. Also inherent in the present invention is the enforced standardization of installation procedures, easing the difficulty with which later problems can be diagnosed, since human choice and error are removed from the installation process.

### SUMMARY OF THE INVENTION

The present invention is a system and method for installing required software on a computer while minimizing the amount of operator intervention required for the installation. The system receives a desired configuration from an operator, generates a build plan that is placed on the recipient computer, and then executes the build plan to cause software to be loaded from a build server onto the recipient computer.

The build plan may include execution instructions to install software onto a recipient computer in accordance with installation packages associated with installation routines for individual programs.

The build plan sequentially executes vendor provided installation programs, with the installation programs being loaded or accessed from a build library, which is connected via a network connection to the recipient computer. The build plan may be subdivided into installation packages with each installation package addressing the installation of a particular software component. Each installation package may be formatted according to a standardized common definition, with the common definition specifying a start command for an installation program, and any necessary parameters for the software installation. These parameters may include a reboot upon completion command, such that installation generated parameters are updated to the operating system before a next software package is installed.

The build plan may also cause a record to be written to an event log upon the completion of each installation package, such that a failure point of a software installation can be determined by identifying the last installation package executed, or by the last entry to the event log. This may allow simple package counting to identify the installation package being installed at the point of failure, and optimally may allow an automated build to be initialized at this point once an installation error has been remedied.

The use of the build plan may also allow the software components installed to be identified based on the installation programs present in the build library at the time of the build, such that a record can be generated based on the build date and the configuration of the build library to identify what revision levels of software were installed on a particular machine. This may allow automated updating to occur at a later date simply by identifying a recipient computer built using a particular revision level of software.

In a simple embodiment, the system of the present invention includes a build library that contains installation programs provided by software suppliers, where the installation programs each configure and install a specific software package onto a recipient computer. A build generating station may also be provided. The build generating station may include build generating software, which generates build plans based on software identified as desired to be installed on a recipient computer. The build library, containing software installation programs, may be made accessible to the recipient computer via a network connection, such as a local net or the Internet.

The present invention is also embodied in a system for installing software onto recipient computers, where the recipient computers are distributed at a plurality of locations. Build libraries may be provided at a plurality of locations, such that the large amount of data required to be transferred from a build library to a recipient computer can be transferred across a local high speed network, as opposed to using a slower long distance network such as the Internet.

At least one build generating station may be provided for generating build plans. The build plans may include a set of instructions identifying software packages to be installed. The plan may reference an installation data package into which parameters required to install a program have been stored. The plan may be in the form of an executable file, or a series of run-once instruction lines inserted into a recipient computer's registry file. The software packages desired to be installed may be identified to a build generating station by a build requester through an interface such as a keyboard and monitor. The build generating station may alternately be a server, such that a build requester can connect to a build generating station via a Network to identify software desired to be installed onto a recipient computer.

In a simple embodiment of the method of the present invention, the method may include the steps of receiving from a build requester information identifying software to be installed on a recipient computer; generating a build plan for installing the identified software onto a recipient computer; transferring the build plan to the recipient computer; and executing the build plan on the recipient computer, wherein the execution of the build plan directs the recipient computer to access data necessary for installing software via a network connection to a build library.

The process may also implement additional functions such as determining whether security tools such as passwords or certificates need to be provided to a recipient computer to enable a software supplier's software installation program to correctly install software requiring authentication of the recipient computer onto a recipient computer. Also, the process may cause an event log to be written after the execution of segments of a build plan, such that the event log can be later reviewed to determine whether the build plan functioned properly, and if not, what software package was not successfully installed, by the absence of an installation event written to the event log.

### BRIEF DESCRIPTION OF THE DRAWINGS

FIG. 1 shows a simple system for automatically building computers according to the present invention.

FIG. 2 shows a process flowchart illustrating the basic method of the present invention.

FIG. 3 shows a process flowchart for generating a build plan.

FIG. 4 shows an exemplary interface for identifying a desired operating system and other parameters to a build generating station.

FIG. 5 shows an exemplary interface for identifying desired software packages for installation onto a recipient computer.

FIG. 6 shows an exemplary interface for providing recipient computer identify information to a build generator.

FIG. 7 shows an exemplary interface for providing network information to a build generator.

FIG. 8 shows an exemplary data structure for providing necessary commands, conditions, and parameters for a software installation to be installed without operator intervention.

FIG. 9 shows simple steps for transferring a build plan from a build generating station to a recipient computer.

FIG. 10 shows steps involved in utilizing a virtual drive on a recipient computer for transferring a build plan.

FIG. 11 shows a process for executing a build plan on a recipient computer.

FIG. 12 shows a process for installing data onto a recipient computer using a disk image disk for creating a portion of the installed software on the recipient computer.

FIG. 13 shows a system for building a recipient computer utilizing a writeable removable memory unit collocated with a build computer, as well as utilizing a build generating station integral with a build server.

FIG. 14 shows a system according to the present invention for building multiple recipient computers located in diverse physical locations.

### DETAILED DESCRIPTION OF THE INVENTION

In the figures, wherein like numerals indicate like elements, there is shown a process and system according to the present invention.

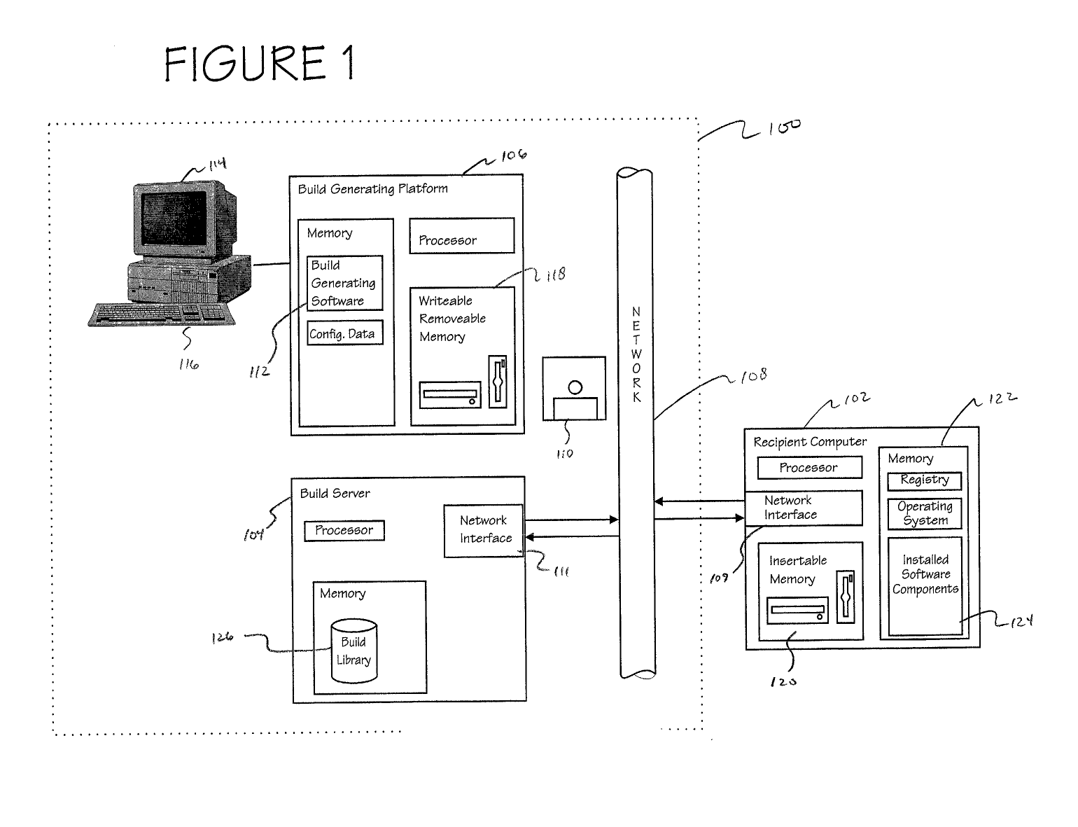

In FIG. 1, there is shown an illustrative system 100 for automatically building a recipient computer 102. The system includes, a build server 104, a build generating platform 106, a communications connection 108 connecting the recipient computer 102 and the build server 104, and a build plan defining a build, illustrated in FIG. 1 as embodied on a floppy disk referred hereafter to as the build disk 110.

The build generating platform 106 includes build generating software 112 for generating a build plan. The build generating software 112 receives a desired build definition from a person (not shown) desiring to have software installed onto a recipient computer 102. Such a person is hereinafter referred to generically as a build requester. The build generating platform also may include a build requester interface, such as a monitor 114 and keyboard 116 allowing a build requester to provide information regarding a desired build directly to the build generating platform 106. This information regarding a desired build is hereinafter referred to as a build definition. A build definition may include identification of a desired operating system, as well as of specific software applications or updates of applications desired to be installed on a recipient computer 102. The build generating software 112 converts a build definition into a build plan which may include an executable file which can be executed by a recipient computer.

The build generating platform 106 also may include a writeable, removable memory device 118, such as a floppy disk drive or a writeable Compact Disk (hereafter “CD”) drive. The purpose of the writeable, removeable memory device 118 is to allow a build plan to be generated, written onto the transferable memory device (such as a build disk 110), and transferred to the recipient computer 102. It is preferred that the medium chosen for the writeable, removable memory device 118 be compatible with an insertable memory device 120 on the recipient computer 102 which can be used to initialize or “boot-up” the recipient computer 102.

The recipient computer 102 is a computer onto which it is desired to install software. The recipient computer may be intended to be a server used to host an application, however the end-usage of the recipient computer 102 is limited only by the ability of the build generating software 112 to generate build plans for installing desired software. The recipient computer 102 preferably includes a communications connection 108 with a build server 104, such as through interfaces 109 and 111 network connected to a network 108, to allow the recipient computer 102 to be able to communicate with the build server 104 to receive data associated with a software installation. As noted above, the recipient computer 102 may also include insertable memory 120, such that a build plan generated on a build generating platform 106 can be transferred to the recipient computer 102. Memory 122, such as a hard drive, may also be included in the recipient computer, such that installed software components 124 can be installed to the memory.

The build server 104 includes a build library 126. The build library 126 may include software installation components that are required to install software to a recipient computer 102. The software installation components may typically be files associated with a software vendor's installation program for installing the software to a computer.

The communications connection 108 between the recipient computer 102 and the build server 104 is preferably chosen based on the specific amounts of data required to be transferred, and the geographic distance between a build server 104 and the recipient computer 102. Where the build server 104 and the recipient computer 102 are co-located, a simple network can be used to allow communications between the build server 104 and the recipient computer 102. If the build server 104 and the recipient computer 102 are not co-located, an Internet connection may be provided, such that data can be transferred from the build server 104 to the recipient computer 102 over the Internet. The use of an Internet network connection is limited by the speed at which data can be transferred, although this limitation may be offset by the desire to provide a single, centralized build server 104 for building recipient computers 102 at multiple remote locations. Network connections may be made using common networking technology. These network connections may of course be wired or wireless in type.

A transferable memory unit for use as a build disk 110 is preferably selected based on the amount of data that can be contained on the unit, as well as based on the compatibility of the transferable memory unit with both a writeable drive on the build generating platform 106, and an insertable drive 120 on the recipient computer 102. Typically, the transferable memory unit may be a floppy disk that is readily available on computers, such as a 3.5″ floppy disk drive. Other transferable memory units may be, but are not limited to, different floppy disk drives, writeable or rewriteable CD drives, Zip drives such as those made by Iomega, tape drives, or removeable hard drives that are compatible with both the build generating platform 106 and the recipient computer 102. Alternatively, a build plan can be transferred to a recipient computer via a network (discussed further below).

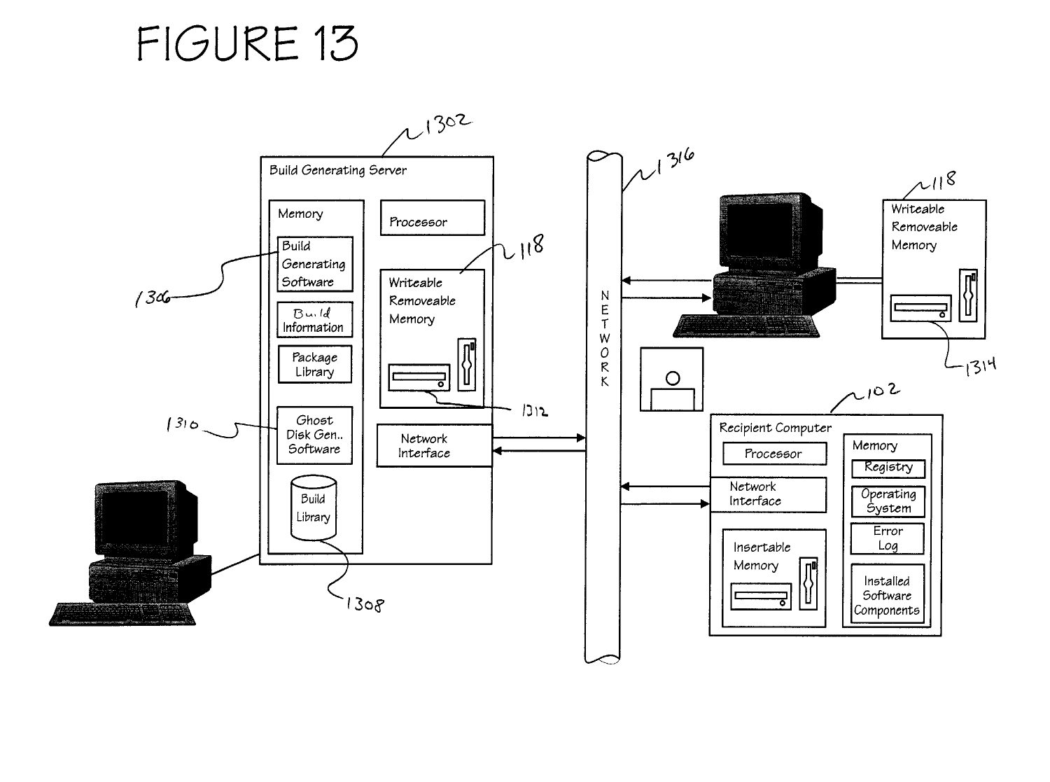

Although the build generating platform 106 and the build server 104 are illustrated in FIG. 1 as two separate computers, the functions may be performed by a single computer onto which build generating software 112 has been installed along with a build library 126 and a network interface 111. Also, the recipient computer 102 may have space in memory 122 for the storage of an event log (shown below in FIG. 13), which can be generated while a build plan is executed to provide a ready source for identifying the success or failure of a software installation.

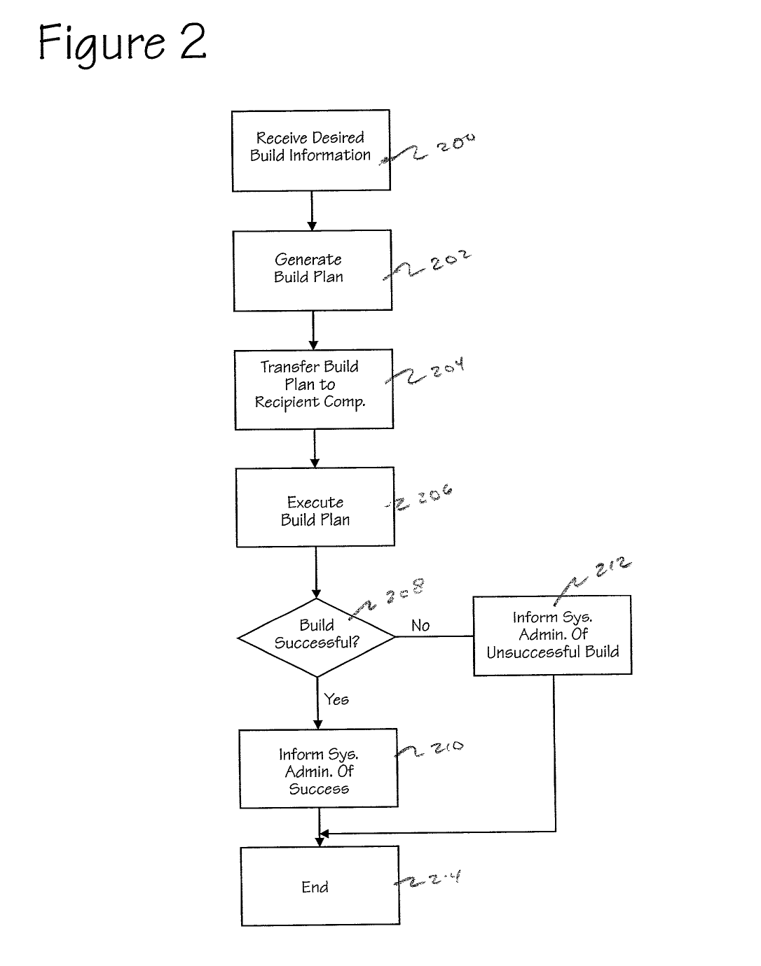

In FIG. 2, there is shown the basic process for accomplishing automated builds of a recipient computer 102. The illustrated embodiment is described as in a Microsoft Windows environment, such that conventions associated with the Windows operating system are utilized herein. As will be apparent to those of ordinary skill in the art, the illustrated embodiment may be implemented for use with an operating system different from Windows.

In the first step, a build definition is received 200 from a build requester. A build plan for the recipient computer may then be generated 202 based upon pre-defined information related to the requested software programs. The build plan may then be transferred 204 to a recipient computer 102. The recipient computer 102 may then execute 206 the build plan. The build plan may instruct the recipient computer to sequentially load software packages. Once the last software package has been installed, the recipient computer may verify 208 the completion of the execution of the build plan. If the build plan executed successfully, the build requester or another person can be notified 210 of the success of the execution of the build plan. If the build was unsuccessful, such as the failure of a software package to install without errors, the build requester can be notified 212 that the build was not successful. Finally, the build plan may end 214.

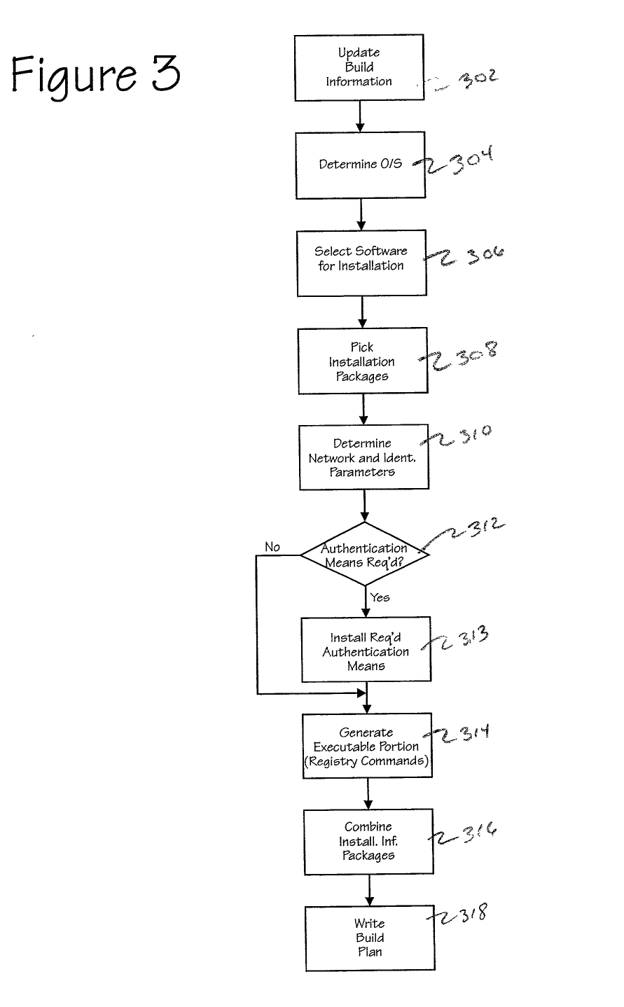

As shown in FIG. 3, the generation of the plan may involve selecting 306 software components to be installed on the recipient computer, and grouping pre-determined installation packages together to form a build plan. First, the process may update 302 information associated with the build generating program to ensure that current information is used for a build. This update may be accomplished by synchronizing a local build information database with a remote master build information database, or by performing sequential queries to the vendors of software available to be installed from a build library 126. If an operating system is to be installed, the operating system can be selected 304. Operating systems to be installed may include, but are not limited to, Windows 2000 or Windows NT, for example. Alternately, an operating system can be selected to define operating system compatibility for software packages to be installed. Once an operating system has been identified, software desired to be installed on a recipient computer can be selected 306.

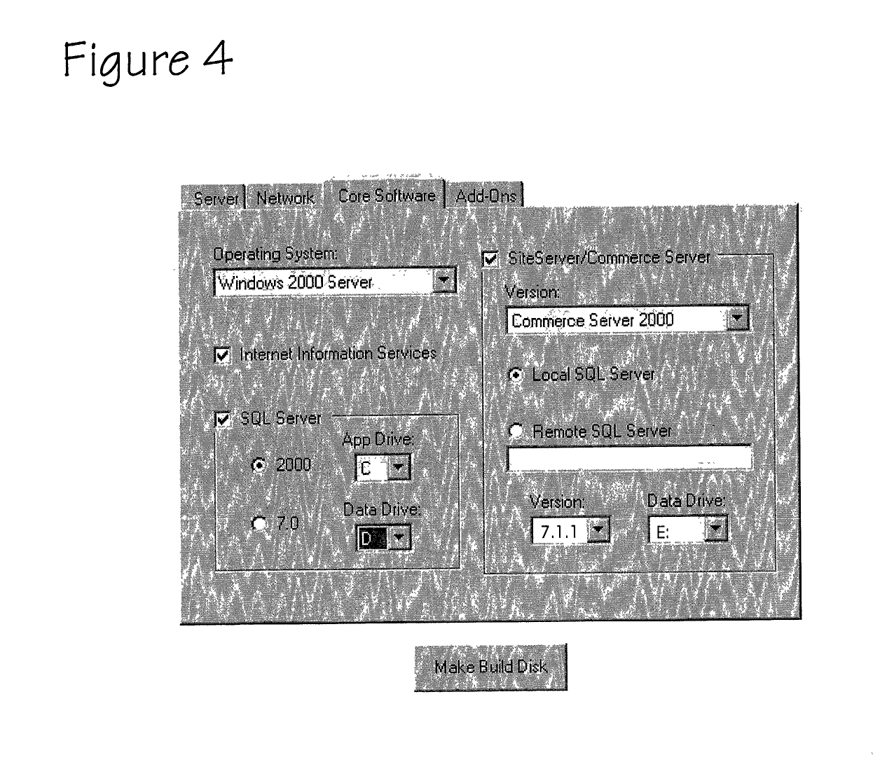

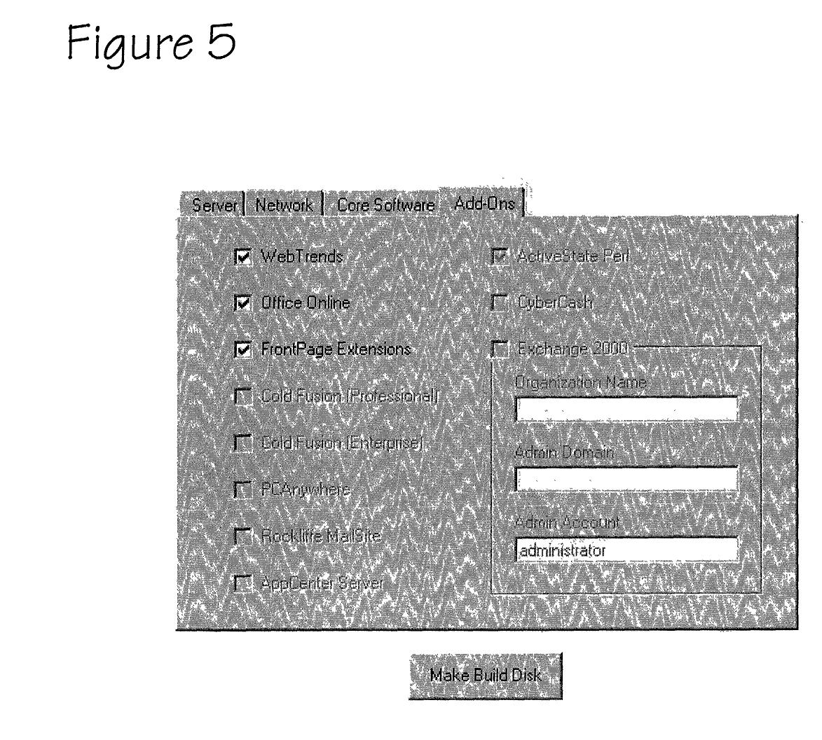

Such a selection 306 is shown in FIGS. 4 and 5. FIG. 4 shows an illustrative build requester interface defining a selected operating system, and buttons for selecting additional components to be installed. FIG. 5 shows an illustrative build requester interface for selecting additional software. Once a build requester has selected desired software for installation, the build generator may pick 308 necessary installation packages for inclusion into the build plan as required to install selected software.

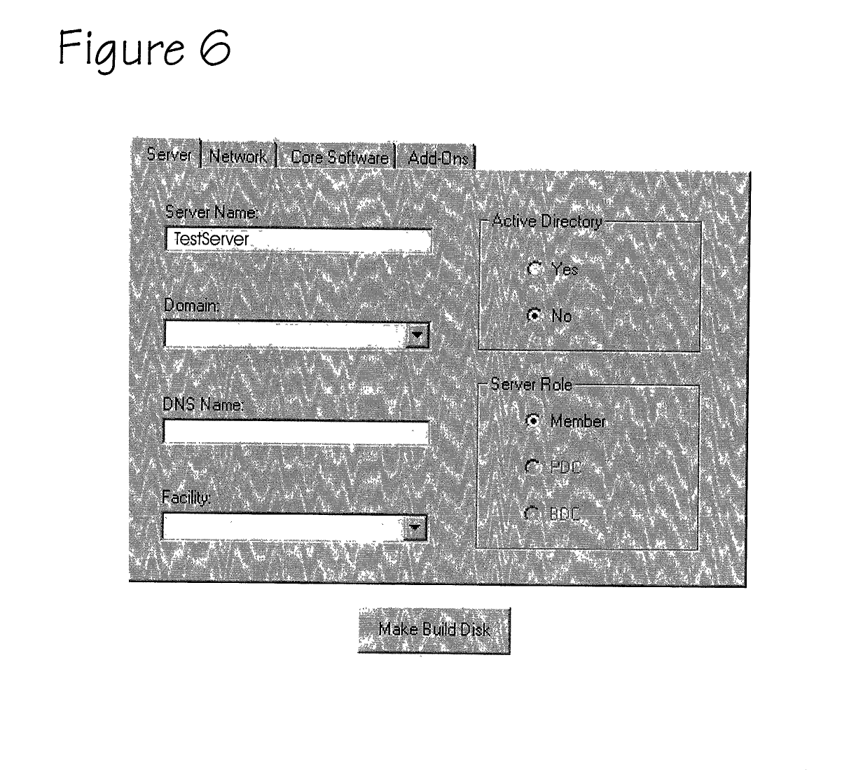

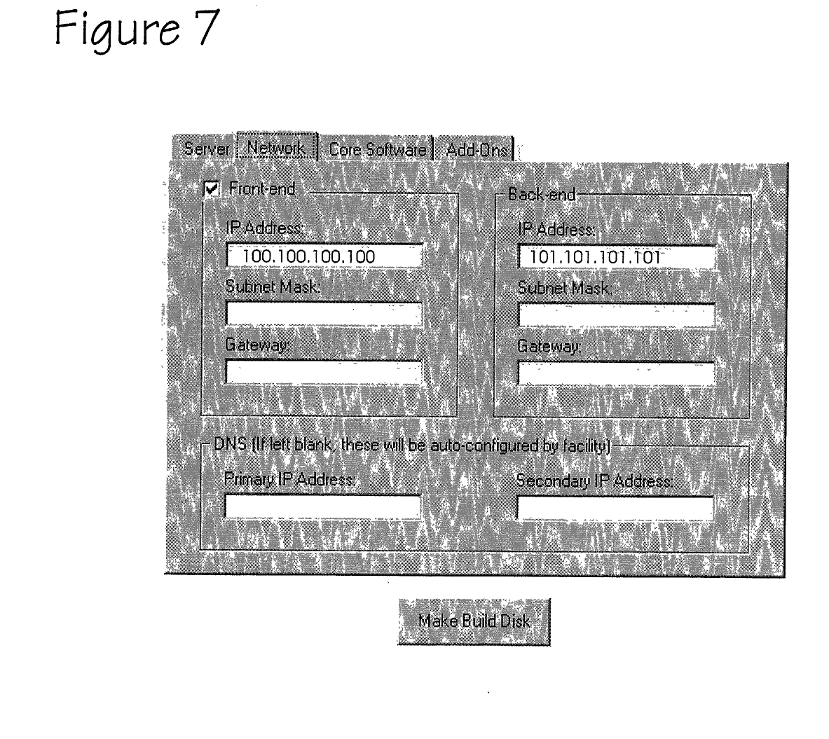

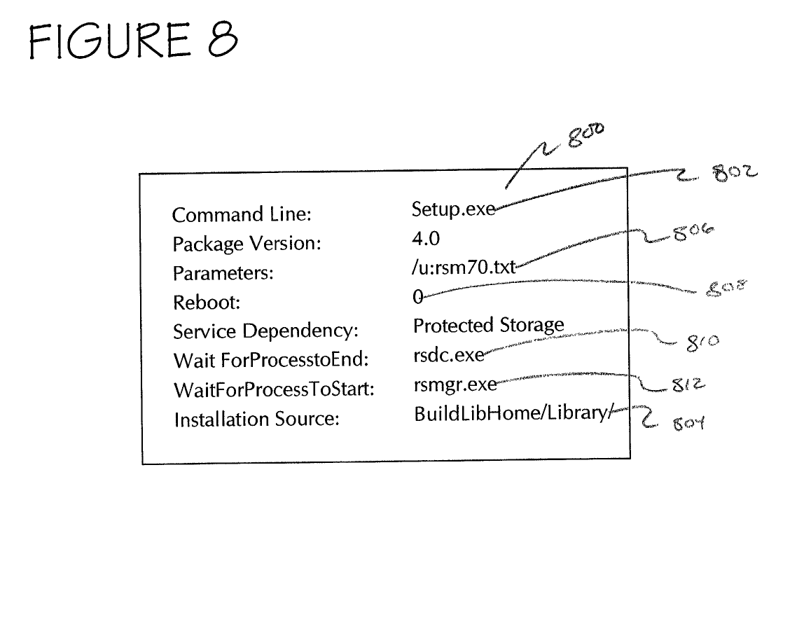

Also, since the recipient computer 102 may be intended to access data necessary to install software onto the recipient computer via a network connection, information necessary for defining a recipient computer's identity on a network, as well as a destination address where the data can be accessed, may need to be identified 310 and provided to the recipient computer 102, as shown in FIG. 6. Alternately, destination addresses may be provided as an element of a build plan. Where the recipient computer 102 is intended to be a host for a hosted application, the build plan may also contain information defining the recipient computer's address for a network. An illustrative build requester interface for defining such data is shown in FIG. 7.

Returning to FIG. 3, as the installation of software across a network may require the presence of authentication means on the recipient computer, the build generator may recognize 312 programs requiring authentication means to be present on the recipient computer, and append 313 instructions for installing necessary authentication means onto the recipient computer in an executable portion of a build plan.

Once the software to be installed on the recipient computer has been selected, the build plan generator may generate a build plan. The build plan may include an executable portion and at least one installation data package identifying parameters for installing a software package. An executable portion of the build plan may prepare the recipient computer for installing selected components, and may direct the execution of vendor provided installation routines. Accordingly, the executable portion of the build plan may need to be customized to recognize network and identity characteristics associated with the recipient computer. Alternately, these characteristics may be made available to an executable portion of a build plan through provision of a data file that can be referenced by the executable portion of the build plan. This data file is referred to herein as an installation data package.

In one implementation of the present invention, the build plan includes references to data installation packages, causing the sequential execution of installation program command lines. As such, each program which may be installed is represented as a individual installation data package. Additionally, where dependencies exist, the build generating software can determine whether additional software services or programs are required to be installed for the requested software to function correctly. Finally, the build generating software can also sequence the references to installation data packages where a correct order of installation is required. The identification of additional software services or programs required and necessary sequencing can be determined by pre-determined configuration matrices where the number of requestable software packages is limited, or can be made by using a “install first” list associated with each installation data package. An install-first list identifies programs that have to be installed before a requested software program can be installed, such that a list of required components can be determined by aggregating all programs identified in requested programs as install-first programs. A sequence can likewise be determined by using the install-first list to ensure that all programs or services which are required to be installed first are installed before a requested program.

Once the elements for the build plan have been accumulated 316, the build generating station may write 318 the build plan to a transferable memory unit for transfer from the build generating station to the recipient computer.

The installation data package may be contained in a data structure 800, as shown in FIG. 8. The data structure may provide a structure of parameters that a build plan can refer to to install a specific software package. By utilizing a data structure common to each installation, the build plan may sequentially perform installations based on the parameters contained in the data structure. As such, the executable portion of the build plan may read the parameters from a presently operable data structure, and transform the parameters into instructions and responses for a recipient computer during an installation procedure.

Parameters for installing a software package may include a command line instruction 802 that initiates installation of a software package. Such command lines may be defined by a writer, manufacturer, or vendor of the software, and may cause an executable program to be run to install the software. The data structure may also include a path 804 for directories within which data necessary to the installation may be stored. Other parameters may include necessary input during an installation routine, such as particular installation settings. These parameters may be contained in a text file 806 that an executable program can access to determine necessary responses to queries during installation. Finally, the data structure may contain a parameter identifying whether the recipient computer should be initialized upon completion of the installation 808 of a software package. In the illustrated data structure, a 0 may mean to reboot after installation, and a 1 may mean that the computer does not need to be initialized after installation.

The data structure illustrated in FIG. 8 furthermore may include parameters for defining for an executable portion of the build plan what other software services need to be started 812 prior to installation of a specific software package, or what other software services must be completed 810 before a specific software package can be installed.

A transferable build plan may also include additional parameters needed for installing software such as a value for the total number of packages to be installed, and instructions for writing an event log that can contain an entry upon the completion of installation of each data package upon the successful installation of that data package.

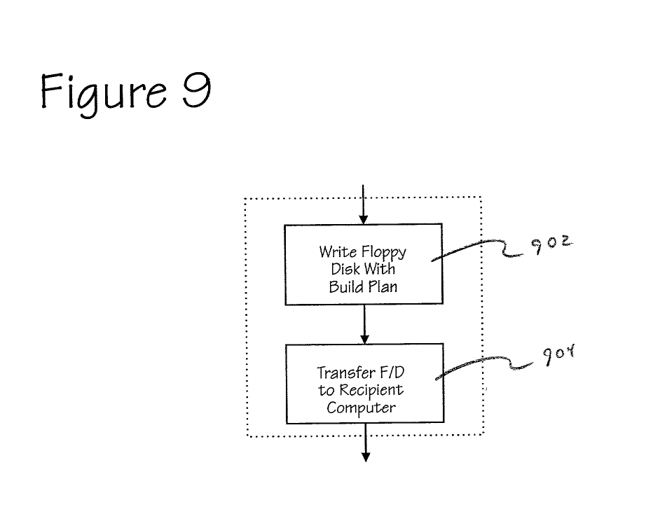

As shown in FIG. 9, the transfer of the build plan from a build generating station on which a plan was generated to a recipient computer may be easily accomplished by writing 902 the plan to a removable disk, and then transferring 904 the removable disk to a recipient computer, such that the recipient computer can execute the plan file upon startup.

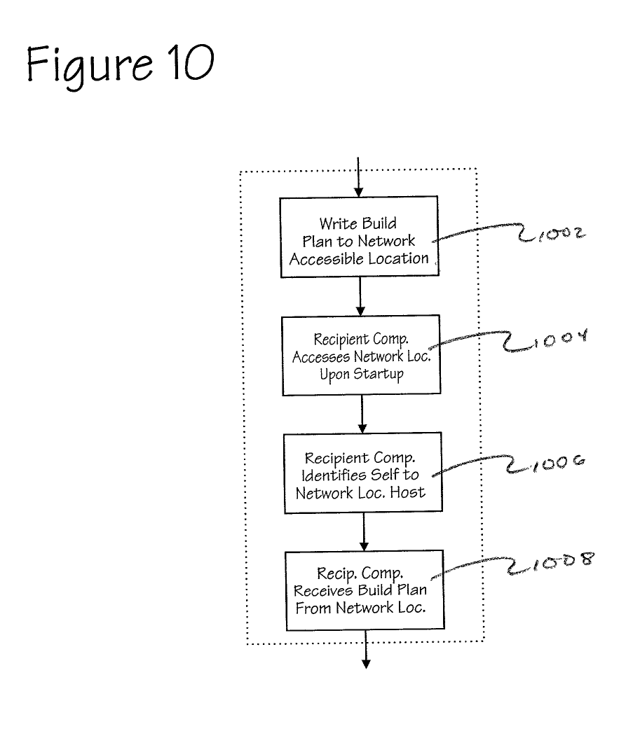

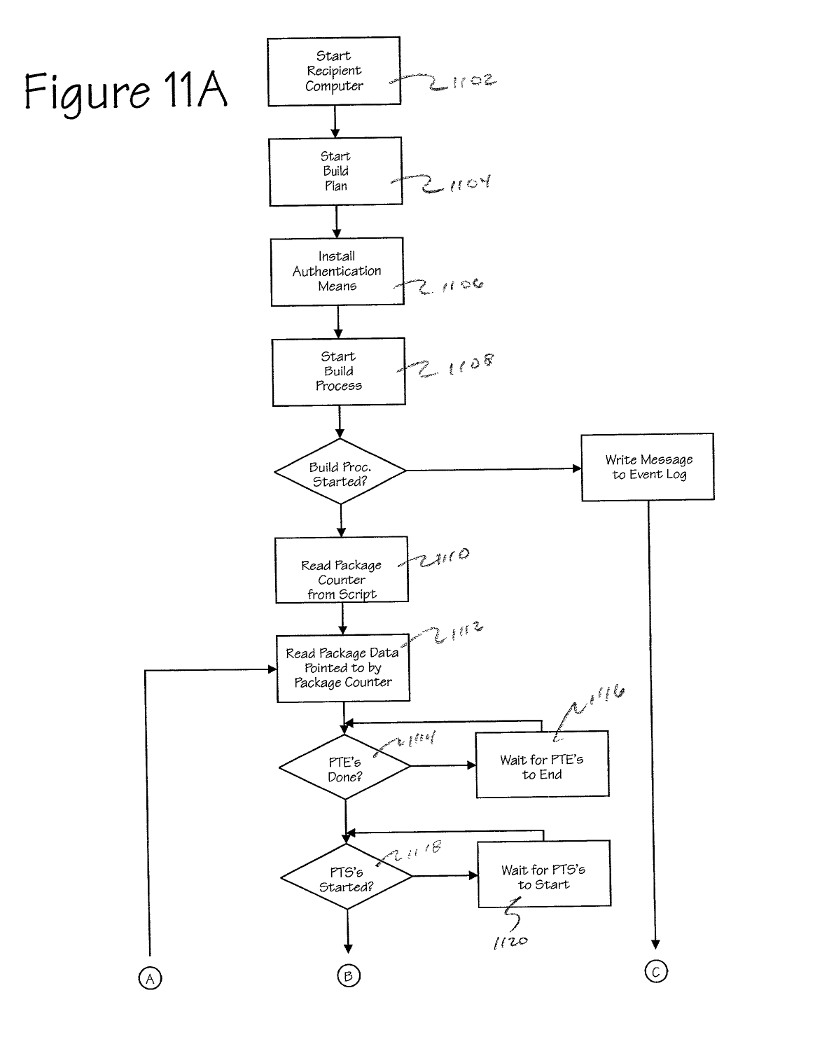

Alternately, as shown in FIG. 10, a recipient computer may incorporate technology which allows creation of a virtual memory location upon startup. This technology may allow a recipient computer to map a network address as a virtual memory device at start-up, such that a plan file stored at a network address may be able to execute within the recipient computer. This process may require the recipient computer to be connected to a network prior to being initialized, as well as may require the recipient computer to be provided with virtual drive hardware. At start-up, virtual device hardware may be instructed to connect via a network to a pre-identified address (stored in non-volatile memory in the virtual drive hardware), identify itself as representing the recipient computer, and access files for use in installing software to a recipient computer. The virtual drive may contain a build plan or other information allowing software to be built to the recipient computer, including, but not limited to, a build plan, authentication files, or specific services or software required for a installation of specific software packages.

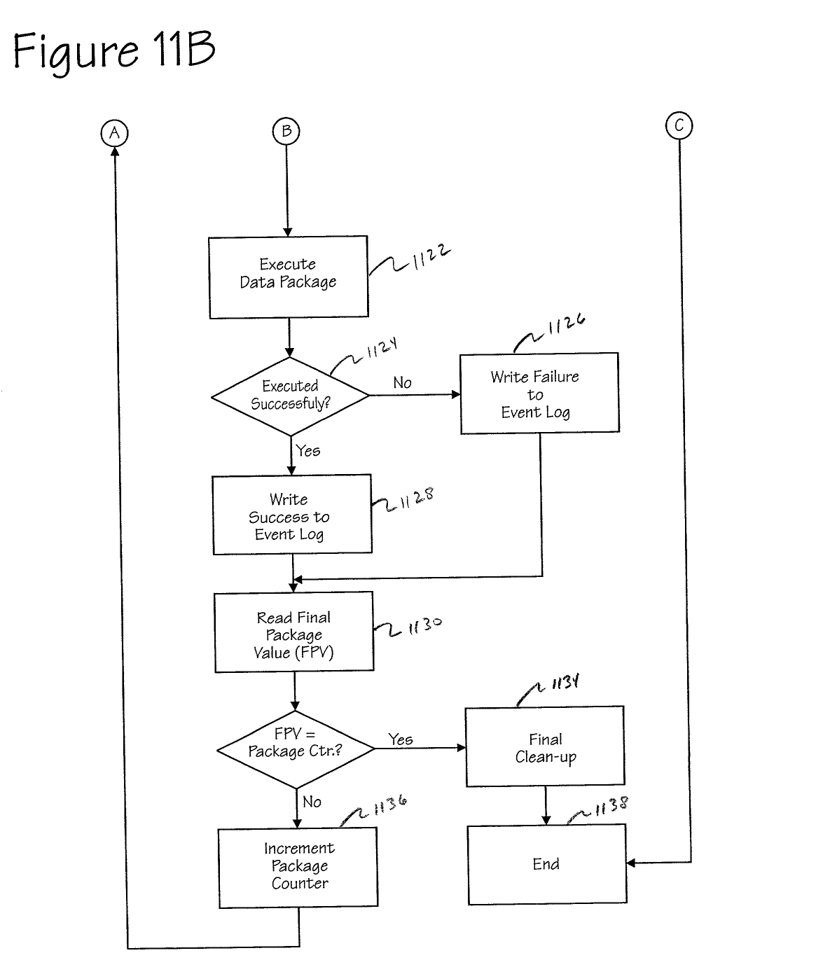

As shown in FIG. 11, the execution of a build plan may comprise several discrete steps. The recipient computer may first be started 1102. This may be accomplished by an operator turning power on to a recipient computer, or, by commanding a recipient computer to re-boot or re-start. If a recipient computer is able to receive commands via a network connection, a re-boot or re-start command can be issued remotely, such as by a build requester responsible for building the recipient computer.

Once the recipient computer has been started, a build plan may be started 1104 on the recipient computer. The starting of a build plan can be automated by implementing the build plan an executable file in the start-up routine of the recipient computer. This can be accomplished, for example, by writing the build plan to a build disk in a form such as a .com file, where the build disk is inserted into a drive that is considered during the start-up routine. Operating systems, such as the many versions of Microsoft Windows, include routines which when a computer is first started, access specific files to start software programs that need to be running for the computer to function. These programs include the operating system itself, as well as services for such tasks as network connections. These programs are started by being placed in the start-up path of the computer, such that the computer runs the executable files in the start-up path when first turned on, or when initialized. By placing a build plan within a start-up path, a recipient computer may be caused to execute a build plan when first initialized.

When installing software, however, it may be preferred to have a minimum of software programs running while the software is being installed. Alternately, specific programs which are not normally part of the start-up path may be required. By forming the build plan as a bootable disk, the recipient computer can be initialized with only those software services necessary for a planned software installation. Necessary software packages can also be included when a recipient computer is initialized, allowing a recipient computer to be in a correct configuration for the installation of software.

A build plan may be a program contained on a bootable disk which is started when the computer is initialized. For example, a build plan may be a file which is automatically executed upon initialization of a recipient computer from the bootable build plan disk, such as a .com file. The specific operating system being used may be relevant to determining the executable file type to be used, since the operating system will define the order in which automatically executed files are executed. For a Microsoft Windows based system, the inclusion of the build plan as a .com file on a bootable disk may cause a recipient computer to load the system configuration contained on the bootable disk, and then to execute the build plan.

An alternate method of causing a build plan to automatically start may be to include the build plan into the registry used by a Windows-type operating system. Individual package installations may be inserted into the registry as run-once command lines, such that when a recipient computer is initialized, it will run the installation instructions in the registry. The use of reboot instructions within individual installation packages may allow a succession of package installations to interrupt the initialization according to the registry as necessary to correctly install a software package. Each successive time a recipient computer initializes, it will read the previously executed package instruction as run, and proceed to the next un-run package installation. Once all package installations have been completed, package installation instructions in the registry may be ignored during start-up.

Use of package installation instructions in the registry may also allow later review of which packages have been installed as a trouble-shooting method. A package counter can be implemented in the registry to increment each time a package is successfully installed, allowing a quick review of whether all packages have successfully installed by comparing the package counter to a value defining the number of packages to be installed.

Once a build plan has started on the recipient computer, the build plan may cause an event log to be created by starting or opening a file on the recipient computer. The purpose of an event log is to be a diary which the build plan may use to record specific events which occur during the execution of the build plan. The event log may be used to contain messages related to the success or failure of the installation of individual software packages, or of errors which occur during execution of the build plan. An event log may also be used to contain status values or flags used during the execution of the build plan, such as an initial value identifying the number of packages to be installed or a value acting as a counter for the number of packages installed.

A build plan may then start any necessary security features necessary to allow desired software to be installed on a recipient computer. For security purposes, an authentication key may need to be running on the recipient computer for a build server to be authorized to transfer data to the recipient computer, as a means of preventing unauthorized use of data contained on a build server. The authentication routine may be a specific authorization that identifies the recipient computer to the build sever, or it may be a series of specific authorizations which identify the recipient computer as being eligible for receiving data associated with specific software packages. If the build plan is unable to start any necessary security features, the build plan may write an error message to the event log, and shut down.

If required security features are successfully started 1106, the build plan may begin 1108 software installation by determining the next package to be installed. The next package to be installed determination may be made by reference 1110 to a present package counter (hereafter PPC), which initially has a value of 1. As such, the first time the build plan executes, the value of the PPC will be 1, and the build plan will read 1112 the first data structure to obtain the necessary commands and parameters for installing a first package. Once the build plan has executed the necessary commands and parameters for the first package (such as waiting for processes to start, installing security or authorization provisions, and issuing an install command) 1114-1120, the build plan may write an entry to an event log evidencing the success 1128 or failure 1126 of the specific installation. Once the entry has been made, a PPC may be incremented 1136, and a reboot command executed if the data structure identifies a need to re-boot after installation of the specific software package.

Execution 1122 of the necessary commands and parameters may involve the build plan issuing a requisite command line instruction for an installation routine. The build plan may also identify a remote directory from which installation data can be extracted. A remote directory identification may be provided in a data structure defining an installation package. Parameters which need to be provided to software installation programs may be provided by the emulation of keyboard entries in accordance with a text file identified as part of a package installation data structure associated with that specific software installation.

The PPC may need to be incremented and written to file before any reboot such that the build plan will be able to reference the correct PPC value when the build plan restarts after a reboot. As long as an incremented value has been stored, the build plan may reference the PPC, which may now point to a next package to be installed.

A build plan may also be provided with a last package value (hereafter “LPV”) that identifies a total number of packages to be installed by a build plan. Before incrementing the PPC, a build plan may determine whether a PPC value is equal to a LPV 1132. If the PPC is equal, the build plan may perform a final cleanup 1134 of the system, such as deletion of temporary files, or removal of any software services needed only for execution of the build plan. Once any final cleanup 1134 has been completed, a build plan may execute instructions to inform an operator near a recipient computer to remove any bootable disks, restart the computer, and end 1138 the process.

Build Using a Disk Image Disk

An alternate embodiment of a process embodying the present invention may utilize a disk image to perform initial software installation to a recipient computer 102. A disk image may include basic software which can be copied to the memory of the recipient computer in a form which is executable without installation, or with reduced installation requirements. Disk image data may include an operating system which can be copied directly to memory 122 of a recipient computer 102.

For example, where a specific configuration of an operating system is desired, an executable operating system may be copied directly to memory on the recipient computer. A disk image may be a removable memory unit such as a floppy disk or a CD-ROM disk. Typically, computers examine drives in a pre-determined order to identify operating software. This order may be to first look to a floppy disk drive, followed by a CD-ROM drive, followed by a principal fixed disk, such as an integral hard-drive partition. Placing a disk image disk in such a path may cause the disk image to be automatically transferred to a recipient computer.

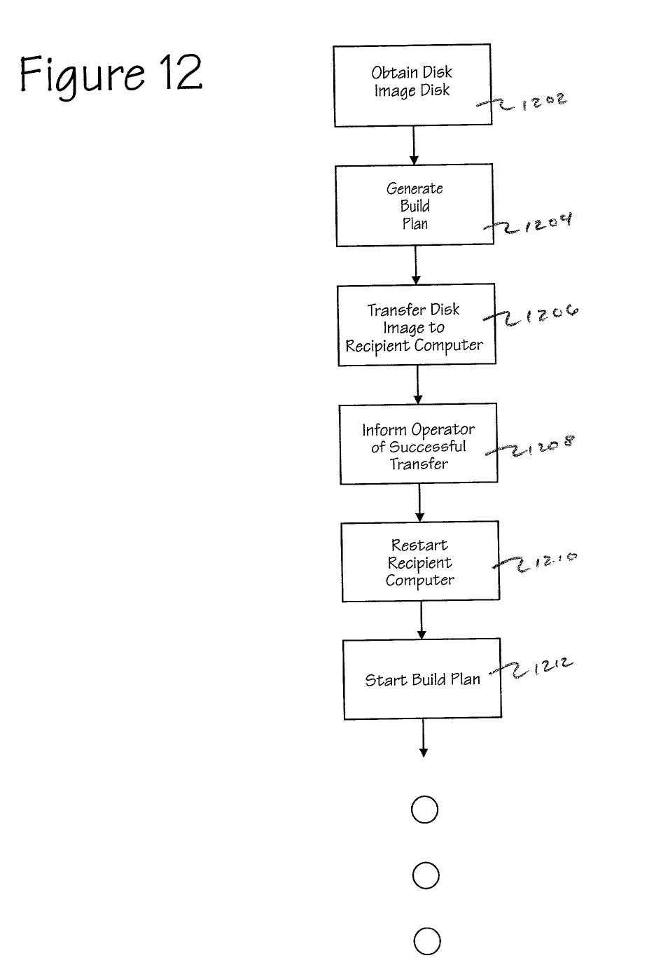

As shown in FIG. 12, building an application host computer or server utilizing a disk image may be accomplished by first generating or obtaining 1202 a disk image for the build. A build plan may then be generated 1204 in accordance with a process as described above in conjunction with FIG. 3. The disk image disk onto which a disk image has been stored may then be inserted 1206 into a recipient computer 102, and the recipient computer initialized. When the recipient computer is initialized with the disk image disk inserted, an executable file on the disk image disk may instruct the recipient computer to transfer the software data contained on the disk image disk into the memory of the recipient computer. Once any such data has been transferred, the recipient computer may inform a system operator that the disk image data has been successfully transferred to the recipient computer 102.

The recipient computer can then have the disk image disk removed to prevent it from interfering with further preparation of the recipient computer. A build process can then be started 1212 by inserting a build disk into the recipient computer, and re-initializing, re-booting, or re-starting recipient computer. If an operating system has been transferred to the recipient computer, the execution of a plan on a build disk may be started 1212 by including the build plan as an executable file in a directory of programs to be executed at start-up. Once the build plan has been started 1212, it may function as described above, repeatedly installing packages until a last package has been installed, then generating a build report for a system administrator.

The use of a disk image disk may require greater operator intervention prior to execution of a build plan, specifically, the operator involvement in first loading the disk image disk, and then loading a build plan disk. The use of a disk image may, however, allow a system administrator to use a specifically tailored component such as an operating system to be the basis for a recipient computer build.

A system for building recipient computers using a disk image and a build disk is included in FIG. 13. The writeable, removable memory unit 118 used to transfer the build plan may also be used to create a disk image disk, if the memory unit is large enough to store information necessary for a disk image. The generating computer is shown as a single build generating server 1302 containing disk image generating software or ghost information 1304, build plan generating software 1306, and a build library 1308, although as described above the individual functions can be performed by a single computer, or a combination of computers performing multiple functions and/or computers performing individual functions.

As shown, the generating computer may have disk image generating software 1310 and disk image generating hardware 1312. Where the disk image is a CD-ROM, the disk image generating hardware 1312 may be a re-writeable CD drive, although the rewriteable CD drive may be located remotely from the generating computer but adjacent to a recipient computer as shown. A remotely located re-writeable CD drive 1314 has the advantage of being able to form a disk image adjacent to a recipient computer 102, but has the disadvantage of requiring the transfer of the disk image information over a network connection 1316.

Geographically Diverse Recipient Computer Locations

Some measurable performance benefit with regard to the transfer of data over a network exists when the geographic distance between a source computer and a destination computer is reduced. As such, web hosting services may desire to locate web servers at diverse locations, such that the response times of the servers can be kept as fast as possible. For example, a web hosting service could provide web servers at a location on the east coast of the United States, at a location on the west coast of the United States, and at a location in Europe, where the web servers at each location are provided for hosting web-sites and applications for entities near the location where the servers are located. Although the web servers may be in diverse locations, there may remain a benefit to a web hosting service to minimize the need to provide redundant services at each facility. Accordingly, the ability of a web host to build servers from a centralized location, remote from a recipient computers, may allow a web host to control the number of build requesters, creating an efficiency for the web hosting provider.

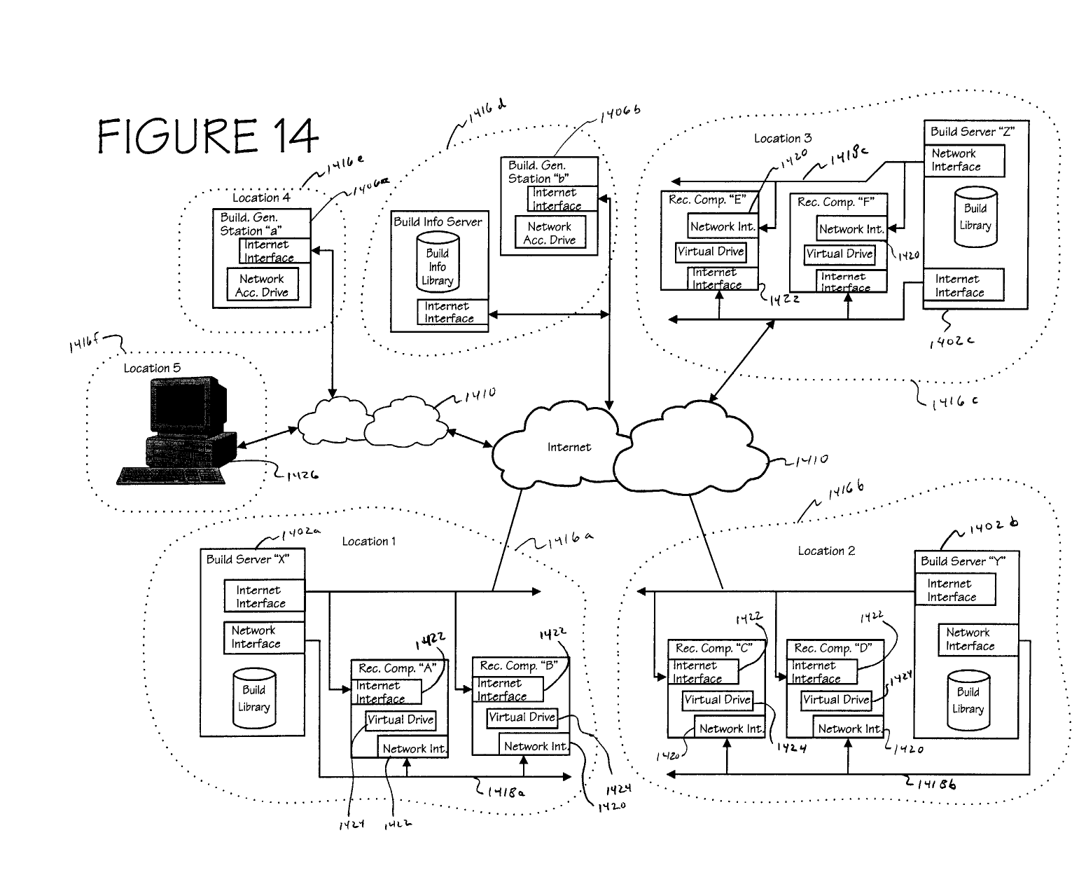

As shown in FIG. 14, the present invention may be adapted to a system allowing a web hosting provider (not shown) to locate build requesters in a limited number of locations, while allowing the same build requesters to control software installations at a variety of diverse locations. By locating build servers 1402a, b, . . . near recipient hosts, the large amounts of data required for software installation programs can be located near recipient computers 1404a, b, . . . , while build generating stations 1406a, b, . . . need only be located at a central location or locations, allowing build requesters to be utilized as efficiently as possible. Alternately a build generating station 1406 can be used as a server, with a build requester connecting to the build generating station 1406 through an Internet appliance 1408 (any means of accessing the Internet, such as a personal computer, box top converter, etc.) via the Internet 1410.

The system shown in FIG. 14 also allows a centralized build information server to be maintained. The centralized build information server 1412 may allow information used in build generating stations 1406 to be controlled at a single point. Data defining parameters and installation instructions for specific software packages may become obsolete over time. For example, a new revision or service pack for a software product may be released. The parameters for the installation of the new revision may differ from the previous version, requiring that data used by each build generating station be updated to reflect the new revision information. If the data which defines each installation package is stored in a distributed fashion, i.e., at each build generating station 1406a, b, . . . then the task of updating the software may be problematic. By centralizing the build information in a build information server 1412, updates to software package information can be accomplished by updating only the single build information server 1412, and having individual build information libraries 1406a, b, . . . reference or mirror the data contained in the build information database 1414.

In an alternate embodiment, the processing required to generate a build plan may be distributed to a web enabled browser associated with a build requester (not shown). In such an embodiment, build generating software can be transferred via the Internet to the build requester's internet appliance, allowing the build requester to generate a build plan at his desk. In this embodiment, the build information may be retained at one or more centralized build information libraries, or may be replicated to the build requester's computer when the build requester transfers the build generating software to the build requester's internet appliance. In order to ensure that only recent versions of the build generating software and build information are used, a build requester may access a build request web site, which causes build generating software in the form of an applet such as Java or ActiveX to be executed on the build requester's internet appliance. By requiring the build requester to reload the applet at each connection to a build generating web server, the build generating software itself can be controlled to ensure that only recent versions are used, while distributing the actual processing required to generate a build plan.

As shown in FIG. 14, build generating stations 1406a, b, . . . may be placed at two or more locations 1416a, b, . . . These build generating stations 1406a, b, . . . may be communicably connected to a build information server 1412, such as through the Internet 1410, although other communications paths such as direct dial-ups may also be utilized. The build information server 1410 may be co-located with a build generating station 1406a, although this is not required for practicing the invention. At different locations, recipient computers 1404, such as those lettered “A” though “F” in the illustration, may be communicably connected to build servers 1402 which are also located at the different locations where the recipient computers 1404 are located. The build servers 1402a, b, . . . may be connected to the co-located recipient computers 1404 through a back-end network 1418, such that data transfer between recipient computers 1404 and the relevant build server 1402 can be accomplished without resort to the Internet 1410. By using a back-end network 1418 for such transfers, the security of the data on a build server 1402 can be more easily preserved, while using high speed networks for the data transfer. Each build server 1402 and recipient computer 1404 may have a network interface 1420 for communicating with this back-end network.

The recipient computers also may have Internet interfaces 1422 allowing the recipient computers to communicate directly with the build generating stations, or to function as a web site host. Alternatively, recipient computers may be in indirect communication through an internet interface to a local build server, and then via a back end network communication to a recipient computer. The use of a virtual drive 1424 on the recipient computers 1404 may allow them to receive a build plan transferred over the Internet 1410, such that a build requester in location “5” may only need a recipient computer 1404 to be turned on for the build plan to be able to be run on the recipient computer 1404.

Alternately, each build server 1402 may be further provided with an Internet interface (not shown) and a writeable removeable memory drive (not shown), such that a build plan can be transferred from a build generating station 1406 to a build server 1402 via the Internet, written to a removeable memory unit at the build server 1402, and transferred to a recipient computer 1404, allowing the recipient computer 1404 to be built as described in conjunction with FIG. 13 above.

Configuration Tracking

The use a of build plan may create a record of what software was installed on a recipient computer, and more importantly, what version of the software was used for the installation. By incorporating the version number for each software package, build plans may be archived and used as a record of the software installation, such that the build plans can be reviewed to determine the version of the software installation on a particular recipient computer.

Also, although build plans as described above are directed towards the installation of software onto a new computer, the invention is not so limited. Build plans may be generated for adding software programs to a previous build by generating a build plan which only identifies the program to be added and any required for installation programs (“install-first” programs). Likewise, service patches, upgrades, and other actions requiring execution of a software supplier supplied installation program can be installed to a recipient computer using a build plan. In particular, a build plan consisting of a single run-once installation package reference could be inserted into a computer's registry to cause the update to be executed the next time the recipient computer is restarted.

As is apparent from the above discussion, the present invention may be embodied in other specific forms without departing from the spirit or essential attributes of the invention. The present invention may be utilized in many applications where enough computers have to be configured to a specific configuration to receive the benefits of automating the process. Accordingly, reference should be made to the appended claims, rather than the foregoing specification, as indicating the scope of the invention.

What is claimed is:

1. A system for installing software onto a recipient computer, comprising:
a build library, said build library including at least one vendor provided installation program for installing a specific software package onto a computer; and
a build generating station, said build generating station having build generating software, said build generating software for generating a build plan which, when executed on a recipient computer, causes software to be installed on the recipient computer utilizing the at least one installation program,
wherein the build library is accessible to recipient computers via a network.

2. A system for installing software onto a recipient computer according to claim 1, wherein the network is the Internet.

3. A system for installing software onto a recipient computer according to claim 1, further comprising a build plan transfer means for transferring a build plan generated on the build generating station to a recipient computer.

4. A system for installing software onto a recipient computer according to claim 3, wherein the transfer means comprises a build plan transfer device associated with the build generating station.

5. A system for installing software onto a recipient computer according to claim 4, wherein the build plan transfer device is a writeable removeable memory unit.

6. A system for installing software onto a recipient computer according to claim 5, wherein the writeable removeable memory unit is a floppy disk drive.

7. A system for installing software onto a recipient computer according to claim 4, wherein the build plan transfer device is a writeable compact disk drive.

8. A system for installing software onto a recipient computer according to claim 3, wherein the transfer means comprises a network interface associated with the build generating station, said network interface communicably connecting the build generating station to a network, said network being accessible to a recipient computer.

9. A system for installing software onto a recipient computer according to claim 1, wherein said build generating station further is for generating build plans which when executed on a recipient computer cause at least one security feature to be provided to a recipient computer.

10. A system for installing software onto a recipient computer according to claim 9, wherein the at least one security feature comprises a certification file.

11. A system for installing software onto a recipient computer according to claim 1, wherein build plans generated by the build generating station include at least one program installation command, said program installation command causing a computer program to be installed onto a recipient computer according to parameters stored in a software installation data package.

12. A system for installing software onto a recipient computer according to claim 11, wherein the software installation data package includes a parameter identifying whether the recipient computer should be initialized upon completion of the installation of a computer program associated with the software installation data package.

13. A system for installing software onto a recipient computer according to claim 11, wherein the software installation data package includes a data field for identifying a text file, said text file identifying data required to be provided to a software installation program in response to queries generated by the software installation program.

14. A system for installing software onto a recipient computer according to claim 11, wherein the software installation data package includes a data field for identifying programs which must be running on a recipient computer for a software installation program associated with the software installation data package to be successfully executed on a recipient computer.

15. A system for installing software onto a recipient computer according to claim 11, wherein the software installation data package includes a data field for identifying programs which can not be running on a recipient computer for a software installation program associated with the software installation package data to be successfully executed on a recipient computer.

16. A system for installing software onto a recipient computer, the system comprising:
a build generator, said build generator including build generating software and a build plan transfer device for transferring a build plan to a recipient computer; and
a build server, the build server including a library of installable software and an interface allowing communications between the build server and a recipient computer,
wherein the build generator generates a build plan, said build plan when executed on a recipient computer causing installable software to be installed on the recipient computer.

17. A system for installing software onto a recipient computer according to claim 16 wherein the build generator further includes an input device, said input device receiving from a build requester information identifying installable software desired to be installed on a recipient computer.

18. A system for installing software onto a recipient computer according to claim 17, wherein the input device comprises a monitor and keyboard connected to the build generator.

19. A system for installing software onto a recipient computer according to claim 17, wherein the input device comprises an Internet appliance connected to the build generator via an Internet connection.

20. A system for installing software onto a recipient computer according to claim 16, wherein the build plan transfer device comprises a writeable removeable memory unit, said writeable removable drive for storing a build plan on a transportable memory unit.

21. A system for installing software onto a recipient computer is according to claim 16, wherein the writeable removable memory drive is located remotely from the build generating station, said writeable removeable memory unit in communication with the build generator.

22. A system for installing software onto a recipient computer according to claim 16, wherein the build generating station and the build server are combined on a single computer.

23. A system for installing software onto a recipient computer according to claim 16, wherein the build generator further comprises a build information database, said build information database containing software installation data package definitions for installing software onto a recipient computer.

24. A system for installing software onto a recipient computer according to claim 16, wherein the build generator creates build plans, wherein said build plans include at least one instruction insertable in a registry.

25. A system for installing software onto a recipient computer according to claim 16, wherein the build generator creates build plans, wherein said build plans comprise an executable file, said executable file capable of being executed automatically upon start-up of a recipient computer.

26. A system for installing software onto a recipient computer according to claim 25, wherein the executable file generated by the build generator further comprises instructions for installing at least one security feature onto a recipient computer.

27. A system for installing software onto a recipient computer according to claim 25, wherein the executable file generated by the build generator further comprises information identifying the recipient computer for a network.

28. A system for installing software onto a recipient computer according to claim 25, wherein the executable file generated by the build generator further comprises information identifying a communications path to a build library.

29. A system for installing software onto a recipient computer according to claim 16, wherein the build generator creates build plans, said build plans comprising at least one installation instruction, said installation instruction utilizing a pre-defined list of parameters for installing a software package, said pre-defined list of parameters including information identifying an installation command for a software installation program and information indicating whether a recipient computer should be restarted upon completion of execution of an installation program.

30. A system for installing software onto a recipient computer according to claim 29, wherein the pre-defined list of parameters further includes a value identifying a text file, said text file including responses required during an installation of a software package onto a recipient computer.

31. A system for installing software onto a recipient computer according to claim 29, wherein the defined list of parameters further includes a value indicating whether additional programs must be running on a recipient computer before an installation program can successfully install software onto a recipient computer.

32. A system for installing software onto a recipient computer according to claim 29, wherein the defined list of parameters further includes a value for identifying software services which are required to be running on a recipient computer before an installation program can successfully install software onto recipient computer.

33. A system for installing software onto a recipient computer according to claim 29, wherein the pre-defined list of parameters further includes a value indicating whether other software services can not be running on a recipient computer for an installation program to successfully install software onto a recipient computer.

34. A system for installing software onto a recipient computer according to claim 29, wherein the pre-defined list of parameters further includes identification of programs which cannot be running on a recipient computer for an installation program to successfully install software onto a recipient computer.

35. A system for installing software onto recipient computers, said recipient computers distributed at a plurality of locations, comprising:
at least one build library recipient computers via a network;
at least one build generating station, said build generating station including build generating software, said build generating software generating build plans in response to information identifying software desired to be installed onto a recipient computer,
wherein said build plans comprise at least one installation instruction, said installation instruction identifying a software package to be installed onto a recipient computer, said installation instruction using a standardized installation data package definition, said standardized installation data package definition capable of defining a plurality of software package installation parameters.

36. A system for installing software onto recipient computers according to claim 35, further comprising a plurality of build libraries, at least one of said build libraries being co-located at each of the plurality of locations at which software is to be installed onto a recipient computer.

37. A system for installing software onto recipient computers according to claim 36, wherein the at least one build generating station further comprises a build plan transfer means for transferring a build plan generated by the build generating station to a recipient computer.

38. A system for installing software onto recipient computers according claim 37, wherein said build library further comprises an Internet interface connecting the build library to the build generating station, wherein the build plan transfer means comprises a build transfer device, said transfer device embodying a build plan on a tangible medium for transfer to a recipient computer.

39. A system for installing software onto recipient computers according to claim 37, wherein said build library further comprises an Internet interface connecting the build library to the build generating station, wherein the build plan transfer means comprises a network, said network accessible by a recipient computer.

40. A system for installing software onto recipient computers according to claim 35, wherein the at least one build generating station further comprises an interface for receiving desired build information from a build requester.

41. A system for installing software onto recipient computers according to claim 40, wherein the interface for receiving desired build information comprises an Internet interface, said Internet interface being connected to the Internet.

42. A system for installing software onto recipient computers, said recipient computers being distributed among at least two locations, comprising:
at least two build libraries, said build libraries distributed among the at least two locations, said build libraries further including a network interface, said network interface accessible by recipient computers co-located with the build library;
at least one build generating station, the at least one build generating station generating build plans in accordance with information identifying software desired to be installed onto a recipient computer, said at least one build generating station receiving information identifying software desired to be installed onto a recipient computer via a build requester interface, said build generating station being communicably connected to a network, said network accessible by recipient computers.

43. A system for installing software onto recipient computers according to claim 42, wherein the build requester interface comprises software for generating build request displays and an internet interface, said build request displays for prompting a build requester to identify software desired to be installed onto a recipient computer, said internet interface for communicating said build request displays to a remotely located build requester via the Internet.

44. A system for installing software onto recipient computers according to claim 42, wherein the at least one build generating station further comprises a build information database, said build information database comprising installation data packages associated with software available for installation from the at least two build libraries, said installation data packages identifying parameters associated with installation programs contained in said build libraries.

45. A system for installing software onto recipient computers according to claim 42, further comprising at least one recipient computer associated with each build library, wherein each recipient computer is communicably connected to the associated build library via a network.

46. A process for installing software onto a recipient computer, comprising the steps of:
receiving from a build requester information identifying software to be installed on a recipient computer;
generating a build plan for installing the identified software onto the recipient computer;
transferring the build plan to the recipient computer;
executing the build plan on the recipient computer, wherein the recipient computer accesses data necessary for installing software via a network connection to a build library.

47. A method of installing software onto a recipient computer according to claim 46, wherein the step of generating a build plan comprises creating an executable file, said executable file including at least one command to execute an installation program on a recipient computer.

48. A method of installing software onto a recipient computer according to claim 47, wherein the step of generating a build plan further comprises the step of determining whether security features are required to be present on a recipient computer for an installation program to successfully execute, and when security features are required, appending instructions to a build plan to install required security features on a recipient computer.

49. A method of installing software onto a recipient computer according to claim 46, wherein the generated build plan comprises an executable file, said executable file when installed on a recipient computer automatically executing when said recipient computer is restarted.

50. A method of installing software onto a recipient computer according to claim 49, wherein the executable file comprises a plurality of command lines, each of said command lines causing a software installation program to be executed on a recipient computer in accordance with information contained in an installation data package.

51. A method of installing software onto a recipient computer according to claim 50, wherein each installation package includes an installation command associated with an installation program for which installation is desired.

52. A method of installing software onto a recipient computer according to claim 51, wherein each installation package further contains a value indicating whether a recipient computer should be restarted upon completion of execution of an installation program.

53. A method of installing software onto a recipient computer according to claim 51, wherein each installation data package further identifies a text file, said text file providing responses for queries from a installation program during execution of the installation program.

54. A method of installing software onto a recipient computer according to claim 51, wherein each data package further comprises a field for identifying programs which are required to be running on a recipient computer in order for an installation program associated with the installation data package to successfully run.

55. A method of installing software onto a recipient computer according to claim 51, wherein each data package further comprises a field for identifying programs which can not be running on a recipient computer in order for an installation program associated with the installation data package to successfully run.

56. A method of installing software onto a recipient computer according to claim 46, wherein the generated build plan comprises a set of at least two run-once instructions, said at least two run-once instructions insertable into a registry file such that said at least two run-once instructions are executed sequentially upon start-up of a recipient computer, where the run-once instructions have been inserted into the registry of the recipient computer.

57. A method of installing software onto a recipient computer according to claim 56, wherein the at least two run-once instructions cause at least two software installation programs to be executed in accordance with sets of parameters identified in installation data packages associated with the installation programs to be executed.

58. A method of installing software onto a recipient computer according to claim 57, wherein each installation data package identifies whether a recipient computer should be restarted upon completion of a installation program associated with the installation data package.

59. A method of installing software onto a recipient computer according to claim 57, wherein each installation data package further identifies a text file, said text file providing responses for queries from an associated installation program during execution of the installation program.

60. A method of installing software onto a recipient computer according to claim 57, wherein each installation data package further comprises a field for identifying programs which are required to be running on a recipient computer in order for an installation program associated with the installation data package to successfully run.

61. A method of installing software onto a recipient computer according to claim 57, wherein each installation data package further comprises a field for identifying programs which can not be running on a recipient computer in order for an installation program associated with the installation data package to successfully run.

62. A computer-readable medium tangibly embodying instructions which, when executed by a computer, implement a process comprising the steps of:
receiving from a build requester information identifying software desired to be installed on a recipient computer;
generating a build plan for installing the identified software onto the recipient computer, said build plan identifying installation parameters associated with software desired to be installed on a recipient computer, said build plan further identifying a source for a recipient computer to access installation programs for software desired to be installed on a recipient computer; and
storing the build plan on media which can be accessed by a recipient computer.

63. A computer-readable medium tangibly embodying instructions according to claim 62, wherein the source for a recipient computer to access installation programs comprises a build library, said build library accessible to a recipient computer via a network connection.

64. A computer readable medium tangibly embodying instructions according to claim 63, wherein the instructions further comprise the steps of determining whether software desired to be installed on a recipient computer requires the presence of a security feature on a recipient computer, and where said security feature is required, including in the build plan instructions for providing the security feature to a recipient computer.

65. A computer readable medium tangibly embodying instructions according to claim 61, wherein the source for a recipient computer to access installation programs comprises source libraries provided by software vendors.

66. A computer readable medium tangibly embodying instructions according to claim 65, wherein the instructions further comprise determining whether software desired to be installed on a recipient computer requires the presence of authentication means on the recipient computer, and where said authentication means is required, including instructions for installing the authentication means with the build plan.

67. A computer readable medium tangibly embodying instructions according to claim 62, wherein said build plan causes run once instruction lines to be inserted into the registry of a recipient computer.

68. A computer readable medium tangibly embodying instructions according to claim 62, wherein said run once instruction lines reference software installation data packages, said data packages containing parameters associated with a desired software installation program.

69. A computer readable medium tangibly embodying instructions according to claim 62, wherein said build plan is an executable file, said executable file being automatically runable during startup when installed on a recipient computer.

70. A computer readable medium tangibly embodying instructions according to claim 69, wherein said executable file contains instructions which cause an event entry message to be written to an event log upon completion of execution of an installation program.

71. A computer readable medium tangibly embodying instructions according to claim 62, wherein the installation parameters include a value identifying whether a recipient computer should be initialized after execution of an installation program.

72. A computer readable medium tangibly embodying instructions according to claim 62, wherein the installation parameters include a data field for identifying programs required to be running on the recipient computer to enable an installation program to install a desired software package.

73. A computer readable medium tangibly embodying instructions according to claim 62, wherein the installation parameters include a data field for identifying programs which can not be running on a recipient computer to allow an installation program to install a desired software package.

74. A build plan for causing a recipient computer to install software onto itself, comprising:
an executable portion, said executable portion including at least one executable instruction, the executable instruction starting at least one software supplier supplied installation program in accordance with an installation data package;
at least one installation data package, said installation data package corresponding to the at least one software supplier supplied installation program, said installation data package identifying a command instruction for executing the at least one software supplier supplied installation program.

75. A build plan according to claim 74, wherein the at least one installation data package includes a value signifying whether a recipient computer should be restarted upon completion of the at least one software supplier supplied installation program

76. A build plan according to claim 74, wherein the at least one installation data package includes an address identifying a location where data required by the at least one software supplier supplied installation program can be accessed.

77. A build plan according to claim 76, wherein the executable portion further comprises an instruction causing the installation of a security feature onto a recipient computer to enable the recipient computer to access data required by the at least one software supplier supplied installation program.

78. A build plan according to claim 77, wherein the security feature is a certificate.

79. A build plan according to claim 77, wherein the security feature is an encryption key.

80. A build plan according to claim 74, wherein the at least one installation data package identifies at least one software service that must be running on a recipient computer before a software supplier supplied installation program can successfully be executed.

81. A build plan according to claim 74, wherein the at least one installation data package identifies at least one software service that must have completed execution prior to a software supplier supplied installation program in order for the software supplier supplied installation program to successfully be executed.

82. A build plan according to claim 74, wherein the at least one installation data package identifies a response file, wherein said response file provides responses to queries, said queries being made by the at least one software supplier supplied installation program.

83. A build plan according to claim 74, wherein the at least one executable instruction comprises a run-once line able to be inserted into a registry on a recipient computer.

84. A build plan according to claim 74, wherein the executable portion further comprises an instruction which causes an entry noting the success or failure of a software supplier supplied installation program execution to be written to an event log.

85. A build plan according to claim 74, wherein the executable portion further comprises at least one instruction which when executed causes network identity information to be provided to a recipient computer.

86. A build plan according to claim 85, wherein the network identity information comprises an address identifying a recipient computer to the internet.

87. A build plan according to claim 85, wherein the network identity information comprises an address identifying a recipient computer to a local network.
